(19) United States
(12) Patent Application Publication
(10) Pub. No.: US 2026/0278003 A1
(43) Pub. Date: Sep. 17, 2026

(54) COMPOUND MESSAGING USING DIRECTED PROPERTY GRAPHS

(71) Applicant: Infosys Limited, Bangalore (IN)

(72) Inventors: Steven SCHILDERS, Indianapolis, IN (US); Chitra THEAGARAJAN, Bengaluru (IN)

(73) Assignee: Infosys Limited, Bangalore (IN)

(21) Appl. No.: 19/076,973

(22) Filed: Mar. 11, 2025

(51) Int. Cl. G06F 16/901; G06F 16/25; G06F 16/903

(52) U.S. Cl. CPC G06F 16/9024; G06F 16/25; G06F 16/90335

(57) ABSTRACT

The present disclosure facilitates compound messaging using directed property graphs. A directed property graph is generated using various messages and entities associated with a digitized system. For each entity, an entity node is created. Further, a compound message is generated that includes messages associated with more than one entity node. A message node representing the compound message is then created and associated with a first entity node. A portion of the compound message is processed using the first entity node, and the remaining portion of the compound message is generated as a new message for processing using other entity nodes.

### FIELD OF THE DISCLOSURE

Various embodiments of the present disclosure relate generally to directed property graphs. More specifically, various embodiments of the present disclosure relate to compound messaging using directed property graphs.

### BACKGROUND

Digitization has emerged as a global phenomenon, transforming traditionally manual processes into highly computerized systems. Advancements in science and engineering have also paved the way for concepts like robotics, artificial intelligence, machine learning, or the like. These innovations span diverse domains, yet they share the same requirement: seamless communication among interconnected modules to accomplish specific tasks. For instance, a warehouse management system relies on individual modules effectively communicating with each other to ensure effective operations.

Traditionally, this inter-module communication has been achieved through the establishment of dedicated communication channels. However, this approach often encounters significant challenges, such as limitations on the number of modules that can connect, increased complexity of the communication architecture, latency in message delivery, channel overloading, or the like. These drawbacks can severely impact the efficiency and reliability of tasks performed by such interconnected systems.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for facilitating compound messaging using directed property graphs are provided substantially as shown in, and described in connection with, at least one of the figures.

In an embodiment of the present disclosure, a system is disclosed. The system includes processing circuitry configured to generate a graph. To generate the graph, the processing circuitry is further configured to create a plurality of entity nodes representing a plurality of entities. The processing circuitry is further configured to create a first message node that represents a first message. The first message comprises a first sub-message linked to a first entity node of the plurality of entity nodes, and a first set of sub-messages linked to a first set of remaining entity nodes of the plurality of entity nodes. The processing circuitry is further configured to associate the first message node with the first entity node, process the first sub-message using the first entity node, and generate, based on the processing of the first sub-message, a second message that comprises the first set of sub-messages. The generated graph facilitates query response generation.

In some embodiments, the first message corresponds to a command-type message or a query-type message.

In some embodiments, to generate the graph, the processing circuitry is further configured to create a second message node that represents the second message, and associate the second message node with the first message node and the first entity node.

In some embodiments, the association between the first message node and the second message node corresponds to a parent-child association, with the first message node being a parent and the second message node being a child.

In some embodiments, to associate the first message node and the second message node, the processing circuitry is further configured to create a message edge between the first message node and the second message node. Further, the processing circuitry is configured to determine, for the message edge, a set of edge attributes that comprises at least one of a group consisting of an identifier of the first message node or an identifier of the second message node. The processing circuitry is further configured to associate the set of edge attributes as edge properties of the message edge.

In some embodiments, the first set of sub-messages of the second message comprises a second sub-message that is linked to a second entity node of the first set of remaining entity nodes. The processing circuitry is further configured to process the second sub-message using the second entity node, and generate, based on the processing of the second sub-message, a third message that corresponds to an event-type message generated as a response to the processing of the second sub-message.

In some embodiments, the second message corresponds to a source message of the third message.

In some embodiments, to generate the graph, the processing circuitry is further configured to create a second message node that represents the second message, associate the second message node with the second entity node, create a third message node that represents the third message, and associate the third message node with the second message node and the second entity node.

In some embodiments, to generate the graph, the processing circuitry is further configured to associate the second entity node with the first entity node.

In some embodiments, the processing circuitry is further configured to generate a fourth message that comprises the third message and an event-type message generated as a response to the processing of the first sub-message.

In some embodiments, to generate the graph, the processing circuitry is further configured to create a second message node that represents the second message, associate the second message node with the second entity node, create a third message node that represents the third message, associate the third message node with the second message node, the second entity node, and the first entity node, create a fourth message node that represents the fourth message, and associate the fourth message node with the first message node, the first entity node, and the third message node.

In some embodiments, the association between the third message node and the fourth message node corresponds to a parent-child association, with the fourth message node being a parent and the third message node being a child.

In some embodiments, the first message corresponds to a source message of the fourth message.

In some embodiments, the first message corresponds to a compound command-type message or a compound query-type message. The fourth message corresponds to a compound event-type message.

In some embodiments, the first message further comprises a second set of sub-messages linked to a second set of remaining entity nodes of the plurality of entity nodes. Based on the processing of the first sub-message, the processing circuitry is further configured to generate a fifth message that comprises the second set of sub-messages. The second set of sub-messages of the fifth message comprises a third sub-message that is linked to a third entity node of the second set of remaining entity nodes. The processing circuitry is further configured to process the third sub-message using the third entity node, and generate, based on the processing of the third sub-message, a sixth message that corresponds to an event-type message generated as a response to the processing of the third sub-message. The fourth message further comprises the sixth message.

In some embodiments, the first set of sub-messages of the second message comprises (i) a second sub-message that is linked to a second entity node of the first set of remaining entity nodes, and (ii) at least one sub-message linked to an entity node, of the first set of remaining entity nodes, that is different from the second entity node. The processing circuitry is further configured to process the second sub-message using the second entity node, and generate, based on the processing of the second sub-message, a seventh message that comprises the at least one sub-message.

In some embodiments, the second message further comprises a modified version of the first sub-message that is derived based on the processing thereof.

In some embodiments, the plurality of entities comprises a root entity. The plurality of entity nodes comprises a central node representing the root entity. The processing circuitry is further configured to generate the first message using the central node.

In some embodiments, to generate the graph, the processing circuitry is further configured to associate the first message node with the central node.

In some embodiments, to associate the first message node with the first entity node, the processing circuitry is further configured to create a message-entity edge between the first message node and the first entity node.

In some embodiments, the processing circuitry is further configured to receive a query that comprises a reference value, and identify, in the graph, at least one node having a data value that is associated with the reference value. The identified node corresponds to one of a group consisting of an entity node or a message node. The processing circuitry is further configured to identify a set of edges associated with the identified node, and identify a set of nodes linked to the identified set of edges. The identified set of nodes includes at least one of a group consisting of one or more message nodes or one or more entity nodes. Further, the processing circuitry is configured to generate a response to the query based on at least one of a group consisting of the identified node, the set of edges, or the set of nodes.

In another embodiment, a method is disclosed. The method comprises generating, by processing circuitry, a graph. The step of generating the graph further comprises creating, by the processing circuitry, a plurality of entity nodes representing a plurality of entities. The step of generating the graph further comprises creating, by the processing circuitry, a first message node that represents a first message. The first message comprises a first sub-message linked to a first entity node of the plurality of entity nodes, and a first set of sub-messages linked to a first set of remaining entity nodes of the plurality of entity nodes. Further, the step of generating the graph comprises associating, by the processing circuitry, the first message node with the first entity node, processing, by the processing circuitry, using the first entity node, the first sub-message, and generating, by the processing circuitry, based on the processing of the first sub-message, a second message that comprises the first set of sub-messages. The generated graph facilitates query response generation.

In another embodiment, a system comprising processing circuitry is disclosed. The processing circuitry is configured to generate a graph. To generate the graph, the processing circuitry is further configured to create a plurality of entity nodes representing a plurality of entities, with a first entity node being associated with a second entity node. The processing circuitry is further configured to generate, using the first entity node, a first message. The first message corresponds to an event-type message generated as a response to message processing using the first entity node. Further, the processing circuitry is configured to create a first message node that represents the first message, associate the first message node with the first entity node and the second entity node, and generate, using the second entity node, a second message. The second message comprises the first message and an event-type message generated as a response to message processing using the second entity node. The generated graph facilitates query response generation.

In some embodiments, to generate the graph, the processing circuitry is further configured to create a second message node that represents the second message, and associate the second message node with the first message node and the second entity node.

In some embodiments, the association between the first message node and the second message node corresponds to a parent-child association, with the second message node being a parent and the first message node being a child.

In some embodiments, to associate the first message node and the second message node, the processing circuitry is further configured to create a message edge between the first message node and the second message node, determine, for the message edge, a set of edge attributes that comprises at least one of a group consisting of (i) an identifier of the first message node or (ii) an identifier of the second message node, and associate the set of edge attributes as edge properties of the message edge.

In some embodiments, the processing circuitry is configured to process, using the first entity node, a third message that corresponds to a command-type message or a query-type message. The processing circuitry generates the first message and the second message as a response to the processing of the third message.

In some embodiments, the third message corresponds to a source message of the first message and the second message.

In some embodiments, the processing circuitry is configured to process, using the first entity node, a third message that corresponds to a command-type message or a query-type message. The processing circuitry is configured to process, using the second entity node, a fourth message that corresponds to a command-type message or a query-type message. The processing circuitry generates the first message and the second message as a response to the processing of the third message and the fourth message, respectively.

In some embodiments, the third message corresponds to a source message of the first message, and the fourth message corresponds to a source message of the second message.

In some embodiments, the second message corresponds to a compound event-type message.

In some embodiments, to generate the graph, the processing circuitry is further configured to generate, using a third entity node of the plurality of entity nodes, a fifth message. The third entity node is associated with the second entity node. The fifth message corresponds to an event-type message generated as a response to message processing using the third entity node. The second message further comprises the fifth message.

In some embodiments, the processing circuitry is further configured to receive a query that comprises a reference value, and identify, in the graph, at least one node having a data value that is associated with the reference value. The identified node corresponds to one of a group consisting of an entity node or a message node. The processing circuitry is further configured to identify a set of edges associated with the identified node, and identify a set of nodes linked to the identified set of edges. The identified set of nodes includes at least one of a group consisting of one or more message nodes or one or more entity nodes. Further, the processing circuitry is configured to generate a response to the query based on at least one of a group consisting of the identified node, the set of edges, or the set of nodes.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a block diagram that illustrates a system environment for compound messaging using directed property graphs, consistent with disclosed embodiments of the present disclosure;

FIG. 2 is a block diagram that illustrates composition of a message, consistent with disclosed embodiments of the present disclosure;

FIG. 3 is a graph illustrating entity nodes and association therebetween, consistent with disclosed embodiments of the present disclosure;

FIG. 4 is a graph illustrating processing of a compound command-type message, consistent with disclosed embodiments of the present disclosure;

FIG. 5 is a graph illustrating processing of a compound event-type message, consistent with disclosed embodiments of the present disclosure;

FIGS. 6A-6C, collectively, represents a flowchart that illustrates a method for facilitating compound messaging using directed property graphs, consistent with disclosed embodiments of the present disclosure; and

FIG. 7 illustrates an example computing system for carrying out the methods of the present disclosure, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

The digitization of manual processes has made efficient communication among interlinked modules paramount. To facilitate this, graphs are commonly employed. Graphs encapsulate entities (e.g., various modules or components of a digitized system) as nodes and their interconnections as edges, enabling seamless visualization and analysis of relationships and dependencies. These graphs are stored in databases and leveraged for various use cases through query processing. To execute an operation using a graph, an application (e.g., a processor) may typically access the required entity nodes of the graph. This access is facilitated through messaging. However, operations often depend on multiple nodes, and the conventional approach requires the application to access each node individually via separate messages. This method not only consumes significant time but also increases the computational and processing burden on the application, reducing overall efficiency.

The present disclosure provides a different approach to facilitate communication between various nodes. The present disclosure discloses a graph (e.g., a directed property graph) generated using various messages and entities associated with a digitized system. For each entity, an entity node may be created in the graph. In a message-driven architecture, data modification is governed by way of messages. A first message may be generated using a central node that represents a root entity. The first message may correspond to a compound command-type message or a compound query-type message. The first message may include messages associated with more than one entity node and can be processed in a hierarchical manner. For example, the first message may include a first sub-message linked to a first entity node and a first set of sub-messages linked to other entity nodes. Further, a first message node representing the first message may be created in the graph, and may be associated with the first entity node. The first sub-message may be processed using the first entity node, and a second message, that comprises the first set of sub-messages, may be generated. Thus, a portion of the compound message is processed at one entity node and the remaining portion of the message is generated as a new message for further processing. The second message may be similarly processed by a second entity node, and in turn, another message may be generated.

Based on each sub-message processing, an event-type message may be generated. The event-type messages may also adhere to the same hierarchical structure as the command-type or query-type messages. Thus, the compound event-type message may be generated using the first entity node and may include the event-type messages hierarchically generated as responses to message processing using all entity nodes. The compound event-type message may thus correspond to a response to the compound query-type message or the compound command-type message.

Such a graph may facilitate the efficient execution of linked tasks. In such a graph, to execute an operation that requires multiple entity nodes, a compound message including sub-messages associated with each entity node may be generated. Further, the compound message may be initially processed using one entity node and the remaining sub-messages may be forwarded to other entity nodes in a hierarchical manner without creating a new transaction. Such compound messaging may consume significantly less time as compared to conventional techniques where each node is accessed via separate messages. Consequently, the computational and processing burden on an application (e.g., processing circuitry) is significantly less, thereby increasing overall efficiency. It is appreciated that the human mind is not equipped to conceptualize an optimized compound messaging using directed property graphs, given the digital interconnectedness of the compound message processing.

### FIGURE DESCRIPTION

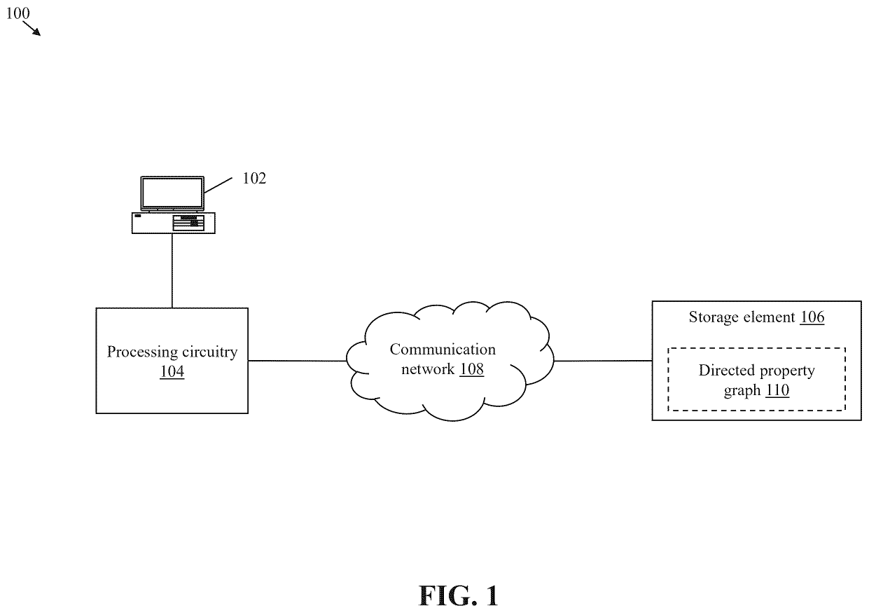

FIG. 1 is a block diagram that illustrates a system environment 100 for compound messaging using directed property graphs, consistent with disclosed embodiments of the present disclosure. In today's fast-paced world, different domains such as finance, healthcare, manufacturing processes, industrial processes, or the like, require real-time analytics for quick and efficient decision-making. Real-time analytics may require optimization at every stage of problem-solving. A problem may be solved by gaining real-time analytics and making decisions thereupon. Typically, a real-world problem may be distributed across different services, with each component of the problem being handled by a specific service. These services may be referred to as microservices. A microservice may be specifically designed to execute a particular task.

With the digitization of manual processes, efficient communication among interlinked microservices has become crucial. To facilitate this, graphs are commonly employed. Graphs encapsulate entities (e.g., various microservices of a digitized system) as nodes and their interconnections as edges, enabling seamless visualization and analysis of relationships and dependencies. To execute an operation using a graph, an application (e.g., a processor) may typically access the required entity nodes of the graph. This access is facilitated through messaging. A message may include data and transactional information associated with the task, and hence, may govern task execution. Typically, operations depend on multiple nodes, and the conventional approach requires the application to access each node individually via separate messages. This method not only consumes significant time but also increases the computational and processing burden on the application, reducing overall efficiency.

The present disclosure provides a solution to implement optimized communication between microservices by utilizing compound messaging in directed property graphs. A directed property graph is a graph data model consisting of nodes, edges, and properties, where edges have direction and both nodes and edges can store key-value pairs, allowing for complex data representation and efficient querying. Referring to FIG. 1, the system environment 100 may include a real-time system 102, processing circuitry 104, a storage element 106, and a communication network 108. The processing circuitry 104 is configured to access the storage element 106 via the communication network 108.

The real-time system 102 may represent a distributed platform that encompasses various microservices for the resolution of real-world problems. Each microservice may correspond to a system entity and may be involved in the execution of various system operations. For example, in a robotic arm system, the shoulder, arms, hands, and fingers may represent entities (e.g., microservices) that may be involved in the execution of various system operations such as waving of hand, picking up an object, or the like.

The processing circuitry 104 may include suitable logic, circuitry, interfaces, and/or code, executable by the circuitry, that may be configured to facilitate compound messaging in directed property graphs. The processing circuitry 104 may be configured to generate (e.g., derive) a directed property graph 110 based on the messages and entities associated with the real-time system 102, and store the directed property graph 110 in the storage element 106. Examples of the storage element 106 may include, but are not limited to, a random-access memory (RAM), a read-only memory (ROM), a removable storage drive, a hard disk drive (HDD), a flash memory, a solid-state memory, or the like.

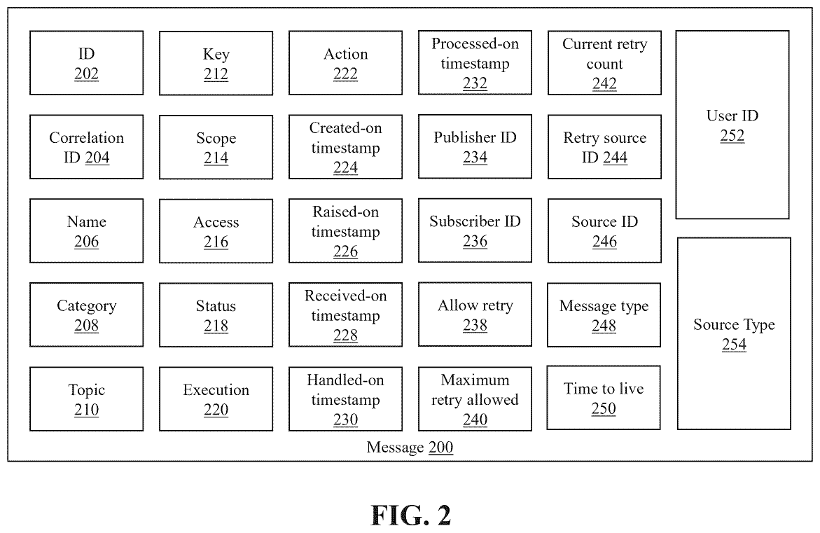

Each message may be associated with various attributes that may correspond to transactional information associated with the real-time system 102. The transactional information may define the composition of the message. Various attributes associated with the message may correspond to an identifier (ID), a correlation ID, a user ID, a name, a category, a topic, a key, a scope, an access, a status, an execution, an action, a message type, a created-on timestamp, a raised-on timestamp, a received-on timestamp, a handled-on timestamp, a processed-on timestamp, a publisher ID, a subscriber ID, an allow retry, a maximum retry allowed, a retry count, a retry source ID, a source ID, and a source type. The composition of the message is described in detail in conjunction with FIG. 2.

### Generation of the Directed Property Graph 110

To generate the directed property graph 110, the processing circuitry 104 may execute various operations. For example, the processing circuitry 104 may be configured to instantiate entity nodes representing the various entities (e.g., microservices) associated with the real-time system 102. The entity nodes may include a central node that represents a root entity (e.g., a brain of the robotic arm system). Further, the processing circuitry 104 may be configured to generate, using the central node, a compound message. The compound message may be a query-type message or a command-type message. The compound message may include sub-messages associated with various entity nodes of the directed property graph 110. The processing circuitry 104 may be configured to create a first message node that represents the compound message. Further, the processing circuitry 104 may be configured to identify a first entity node that is associated with the compound message, and associate the first message node with the first entity node. Based on the association, the processing circuitry 104 may be configured to process, using the first entity node, a sub-message of the compound message that is linked to the first entity node. Further, based on the sub-message processing, the processing circuitry 104 may be configured to generate a new message that may include the remaining sub-messages of the original compound message. The new message may be then forwarded to another entity node using which a different sub-message may be processed. The process may continue in a hierarchical manner until the last sub-message is processed using the corresponding entity node.

Thus, in a single transaction and using a single compound message, multiple entity nodes may be accessed and corresponding operations may be executed. To summarize, in the directed property graph 110, to execute an operation that requires multiple entity nodes, a compound message including sub-messages associated with each entity node may be generated. Further, the compound message may be initially processed using one entity node and the remaining sub-messages may be forwarded to other entity nodes without creating a new transaction. Such compound messaging may consume significantly less time as compared to conventional techniques where each node is accessed via separate messages. Consequently, the computational and processing burden on an application (e.g., the processing circuitry 104) is significantly less, thereby increasing overall efficiency.

In response to the sub-message processing, an event-type message may be generated at each entity node. In such a scenario, the processing circuitry 104 may be configured to create a message node for each event-type message. The event-type message may also adhere to the same hierarchical structure as the command or query messages. Thus, a compound event-type message may be generated using the first entity node where the first sub-message was processed, and may include all event-type messages generated as responses to the sub-message processing.

The aforementioned process may be executed for various compound messages generated for the real-time system 102. Such a structure of the directed property graph 110 may facilitate optimized query response generation.

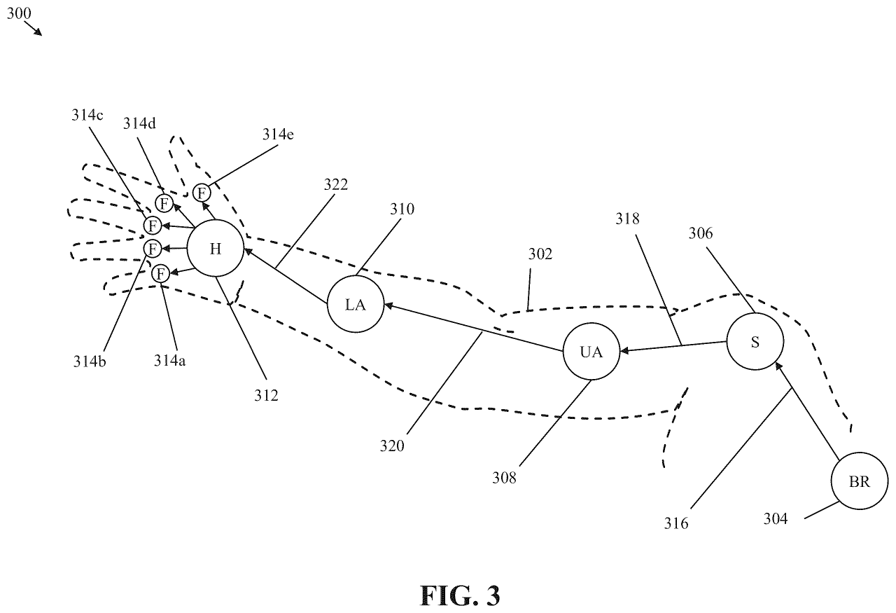

The structure of the directed property graph 110 and the operations of the processing circuitry 104 are explained in detail in conjunction with FIGS. 3-6.

The processing circuitry 104 may be implemented by one or more processors, such as, but not limited to, an application-specific integrated circuit (ASIC) processor, a reduced instruction set computer (RISC) processor, a complex instruction set computer (CISC) processor, and a field programmable gate array (FPGA) processor. The one or more processors may also correspond to central processing units (CPUs), graphics processing units (GPUs), neural processing units (NPUs), digital signal processors (DSPs), or the like. It will be apparent to a person of ordinary skill in the art that the processing circuitry 104 may be compatible with multiple operating systems. The processing circuitry 104 may further include one or more components (for example, a parser, a loader, or the like) that may be configured to execute one or more operations to be executed by the processing circuitry 104.

The communication network 108 is a medium through which instructions and data are transmitted between the processing circuitry 104 and the storage element 106. Examples of the communication network 108 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, microwave communication, and a combination thereof. Examples of the communication network 108 may further include a Narrow Band-Internet of Things (NB-IoT) network, a 5G network, a 4G network, a long-range (LoRa) wireless technology network, a ZigBee network, an Ipv6 Low-power Wireless Personal Area Network (6LowPAN), or the like. Various entities (such as the processing circuitry 104 and the storage element 106) in the system environment 100 may be coupled to the communication network 108 in accordance with various wired and wireless communication protocols, such as Transmission Control Protocol and Internet Protocol (TCP/IP), User Datagram Protocol (UDP), Long Term Evolution (LTE) communication protocols, or any combination thereof.

Although the present disclosure describes the generation and utilization of a directed property graph (e.g., the directed property graph 110), the scope of the present disclosure is not limited to it. In numerous embodiments, other types of graphs, such as undirected graphs, weighted graphs, bipartite graphs, or the like, may be utilized without deviating from the scope of the present disclosure.

The scope of the present disclosure is not limited to a standalone realization of the storage element 106, as described herein. In numerous embodiments, the storage element 106 can be realized in the form of a database server or a cloud storage working in conjunction with the processing circuitry 104, without departing from the scope of the present disclosure.

FIG. 2 is a block diagram that illustrates composition of a message 200, consistent with disclosed embodiments of the present disclosure. The message 200 may correspond to one of a command-type message, a query-type message, or an event-type message. The message 200 may be associated with the real-time system 102. The message 200 may include data and transactional information. Data included in the composition of the message 200 may refer to the message payload. In other words, the data in the composition of the message 200 refers to a statement, an instruction, a message, a command, a query, or the like, that is being communicated via the message 200.

Referring to FIG. 2, the composition of the message 200 includes a plurality of attributes that form the transactional information associated with the message 200. The plurality of attributes may include an ID 202, a correlation ID 204, a name 206, a category 208, a topic 210, a key 212, a scope 214, an access 216, a status 218, an execution 220, an action 222, a created-on timestamp 224, a raised-on timestamp 226, a received-on timestamp 228, a handled-on timestamp 230, a processed-on timestamp 232, a publisher ID 234, a subscriber ID 236, an allow retry 238, a maximum retry allowed 240, a current retry count 242, a retry source ID 244, a source ID 246, a message type 248, a time to live 250, a user ID 252, and a source type 254. Though the data associated with the message 200 is not shown in FIG. 2, it will be apparent to a person skilled in the art that the composition of the message 200 includes the data to be communicated by the message 200.

The ID 202 is a unique ID associated with the message 200 and may be used by the processing circuitry 104 to identify the message 200.

The correlation ID 204 is an ID that is shared among messages that are related. The correlation ID 204 may be used to join and correlate one or more messages in a transaction flow such as a command-to-event, a query-to-event, or the like. Each sub-message (e.g., child message) of a compound message (e.g., parent message) may include a hierarchical correlation ID. Further, sub-messages at the same level of hierarchy may have identical data values for the correlation ID 204. Sub-messages at each subsequent hierarchical level may further include data values of the correlation ID 204 of sub-messages at previous hierarchical levels. Each sub-message may also include a root ID that is associated with the parent message.

The name 206 is a human-understandable descriptor of the message 200 and is solely included for the ease of understanding of users associated with the real-time system 102.

The category 208 is a human-understandable descriptor of a domain or criterion of the message. For example, a data value of the category 208 of the message 200 may be an order management message.

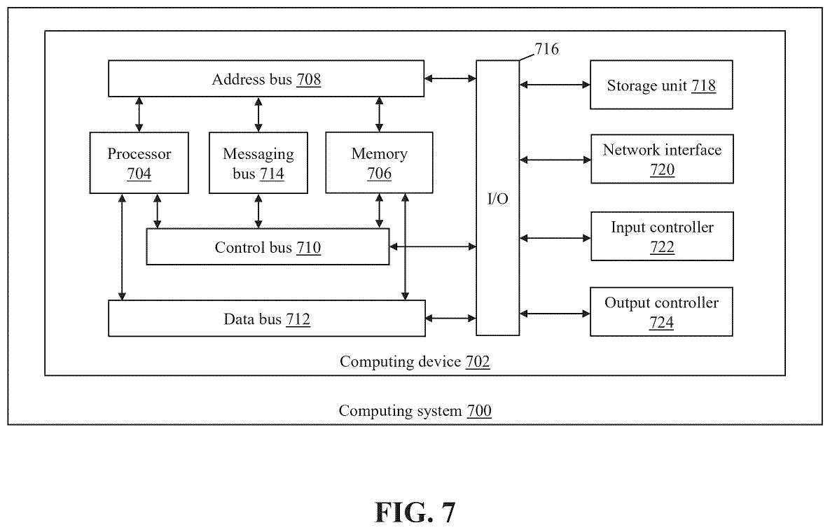

The topic 210 is a human-understandable descriptor of a topic/domain/subject/agenda associated with which the message 200 has been published. Notably, the topic 210 allows the grouping of multiple messages irrespective of their category. Each message may be associated with a single data value of the topic 210. Notably, multiple messages may be associated with the same data value of the topic 210. Each data value of the topic 210 may have one or more subscribers (for example, one or more microservices). The subscriber may handle the message 200 associated with a topic. Each data value of the topic 210 may be published/scheduled for processing using a specific pipeline of a messaging bus (shown in FIG. 7).

The key 212 corresponds to a unique ID associated with a root data node for which the message 200 may be created. The root data node may be further processed by one or more messages, each representing a different transaction. In such a case, the data value for the key attribute of the one or more messages may be identical to the data value of the key 212 associated with the message 200. The identical data value of the key associated with the one or more messages may allow to maintain an order of the one or more messages in a message queue within the topic 210 based on the processing of the one or more messages on the root data node. Further, the key 212 is used to establish a single partition in the message queue of a messaging system (for example, Kafka) such that the one or more messages may be stored and consumed in the exact order in which they were produced. In an embodiment, if the root data node is processed by two different transactions, i.e., by two different messages, the processing order of the two messages may be maintained for one or more handler microservices that may subscribe to these messages. Utilization of the key 212 allows the sending of these messages to the same partition so that the one or more handler microservices may subscribe to these messages from the same partition.

The scope 214 ensures appropriate security of the message 200. Data values of the scope 214 may be internal or external. When the data value of the scope 214 is internal, the message 200 may be internal, e.g., the message 200 may be communicated between one or more microservices associated with a host system. Alternatively, when the data value of the scope 214 is external, the message 200 may be external, e.g., the message 200 may be communicated between a microservice associated with a native system and different microservices associated with an external system. Therefore, the data value of the scope 214 may be one of internal, external, or internal and external.

The access 216 determines access permission to the message 200. In an instance, when a data value of the access 216 is public, a user trying to access the message 200 is not required to be authenticated prior to the access. In another instance, when the data value of the access 216 is private, a user trying to access the message 200 is required to be authenticated prior to accessing the message 200.

The status 218 is indicative of the progress of execution of the message 200. A data value of the status 218 of the message 200 may be one of created, raised, received, handled, or processed.

The execution 220 is indicative of a path that is to be traveled by the message 200 to reach its destination node. The data value of the execution 220 may be synchronous or asynchronous. In an instance, when the data value of the execution 220 is asynchronous, the message 200 may follow a transaction path that is loosely coupled. That is to say, the message 200 generated by a producer microservice may be communicated to a consumer microservice by way of a message-oriented middleware, such as Kafka, RabbitMQ, or the like. In another instance, when the data value of the execution 220 is synchronous, the message 200 may follow a transaction path that is not loosely coupled. For example, in the case of an application using a messaging mechanism, a built-in application programming interface (API) may be utilized that may allow communication of the message 200 within the application without relying on an external message-oriented middleware.

The action 222 is indicative of an action or operation to be performed by a microservice that subscribes to the message 200.

The created-on timestamp 224 includes details (such as time, date, day, month, or the like) regarding the creation of the message 200 by its source microservice.

The raised-on timestamp 226 includes details (such as time, date, day, month, or the like) regarding the publication of the message 200 on a communication bus by its source microservice. The communication bus forms a channel between a source microservice and a destination microservice of the message.

The received-on timestamp 228 includes details (such as time, date, day, month, or the like) regarding when the message 200 was received by the destination microservice but has not been processed.

The handled-on timestamp 230 includes details (such as time, date, day, month, or the like) associated with a point in time when the processing of the message 200 is initiated.

The processed-on timestamp 232 includes details (such as time, date, day, month, or the like) regarding when the processing of the message 200 gets completed.

The publisher ID 234 is a unique ID for a publisher microservice that has published the message 200. A data value of the publisher ID 234 may be associated with the source microservice or an intermediate microservice.

The subscriber ID 236 is a unique ID for a handler microservice(s) that subscribes to the message 200. Notably, a command-type message and a query-type message may be subscribed to by a single microservice, whereas an event-type message may be subscribed to by multiple microservices and each microservice may receive a copy of the event-type message.

The allow retry 238 ensures successful communication and processing of the message 200. A data value of the allow retry 238 determines if the message 200 is to be re-published in case the status of the message 200 is a failure or partial failure. The re-published message may be a clone of the original message 200.

The maximum retry allowed 240 determines the maximum count for which the message 200 is to be re-published in case the status of the message 200 is a failure or a partial failure.

The current retry count 242 keeps track of the number of times for which the message 200 is re-published. That is to say that the current retry count 242 is indicative of a current count of re-publications of the message 200. The data value of the current retry count 242 gets incremented with each re-publication of the message 200.

The retry source ID 244 included in the message 200 is a unique ID of an original message that is being re-published. The retry source ID 244 is required as a clone message with a different ID is generated and published during the re-publication of the message 200. The clone message has timestamps (e.g., created-on timestamp, received-on timestamp, or the like) that are different from the timestamps included in the message 200. Therefore, to link the clone message to the message 200, a data value of the retry source ID 244 is included in the clone message.

The source ID 246 represents an object that initiated the message creation. For example, if a user experience (UX) initiates a transaction, the data value of the source ID 246 may correspond to the data value of an ID of the UX control/page. In another embodiment, the source ID 246 is included in the message 200 if the message 200 has originated from another message. For example, an event-type message that is created in response to the processing of a command-type message may have a data value of the source ID 246 that is identical to the data value of the ID 202 of the command-type message.

The message type 248 is indicative of the message 200 being one of a command message, a query message, or an event message. The message type 248 may further include a flag, where a value ‘1’ of the flag may indicate that the message represented by the message 200 is a leaf message, whereas a value ‘0’ of the flag may indicate that the message 200 is a composite message. The leaf message does not have any sub-messages, whereas the composite message is a message having one or more sub-messages. In other embodiments, composite and leaf messages may be indicated differently without deviating from the scope of the disclosure.

The time to live 250 may be indicative of a time period during which the message 200 may be valid. Therefore, the message should be communicated and processed within a duration that is indicated by a data value of the time to live 250. In an instance of failure or partial failure, the message 200 should not be re-published once the time period indicated by the data value of the time to live 250 has lapsed. Notably, the lapse of the time period indicated by the data value of the time to live 250 is indicative of message 200 being invalid.

The user ID 252 has a corresponding data value that is a unique ID associated with a user of the real-time system 102 that may have generated the message 200.

The source type 254 refers to a source that may have caused the generation of the message 200. In an embodiment, a data value of the source type 254 may be one of command, query, and event. In another embodiment, the data value of the source type 254 may be a non-message type.

The composition of the message 200 described in FIG. 2 may be used by the processing circuitry 104 for performing the analysis of the message. Such analysis may be performed to determine one or more analytical insights related to the performance of the business solution associated with the real-time system 102.

The plurality of attributes associated with the message 200 may include one or more attributes that comprise static information and one or more attributes that comprise dynamic information. The static information may be assigned to the one or more attributes at the time of the creation of the message 200, whereas the dynamic information may be assigned to the one or more attributes during the processing of the message 200. The one or more attributes with static information may correspond to ID 202, the correlation ID 204, the name 206, the category 208, the topic 210, the key 212, the scope 214, the access 216, the execution 220, the action 222, the allow retry 238, the maximum retry allowed 240, the retry source ID 244, the source ID 246, the source type 254, and the user ID 252. Further, the one or more attributes with dynamic information may correspond to the status 218, the created-on timestamp 224, the raised-on timestamp 226, the received-on timestamp 228, the handled-on timestamp 230, the processed-on timestamp 232, the publisher ID 234, the subscriber ID 236, and the current retry count 242.

It will be apparent to a person skilled in the art that the composition of the message 200 described in conjunction with FIG. 2 is non-limiting, and in other embodiments, components included in the message 200 may differ from the components depicted in FIG. 2.

FIG. 3 is a graph 300 illustrating entity nodes and association therebetween, consistent with disclosed embodiments of the present disclosure. The graph 300 may correspond to a portion of the directed property graph 110. Referring to FIG. 3, the graph 300 may be generated for a robotic arm 302.

The robotic arm 302 includes various entities such as a brain, a shoulder, an upper arm, a lower arm, a hand, and fingers. In such a scenario, to generate the graph 300, the processing circuitry 104 may be configured to create a plurality of entity nodes representing the plurality of entities of the robotic arm 302. For example, the processing circuitry 104 may create a brain entity node 304 for the brain entity, a shoulder entity node 306 for the shoulder entity, an upper arm entity node 308 for the upper arm entity, a lower arm entity node 310 for the lower arm entity, and a hand entity node 312 for the hand entity. Further, the processing circuitry 104 may create finger entity nodes 314a-314e for the five finger entities. The brain entity node 304, the shoulder entity node 306, the upper arm entity node 308, the lower arm entity node 310, the hand entity node 312, and the finger entity nodes 314a-314e are hereinafter referred to as the “brain node 304”, the “shoulder node 306”, the “upper arm node 308”, the “lower arm node 310”, the “hand node 312”, and the “finger nodes 314a-314e”, respectively. Such entity nodes may be connected in a hierarchical structure. For example, the brain node 304 may act as a root, the shoulder, the upper arm, the lower arm, and the hand nodes 306-312 may act as intermediate nodes, and the finger nodes 314a-314e may act as leaves, of the hierarchical structure of the graph 300.

The processing circuitry 104 may be further configured to associate the entity nodes with each other. In an embodiment, the processing circuitry 104 may be configured to create a plurality of edges to associate the entity nodes with each other. For example, the brain node 304 may be associated with the shoulder node 306 by way of an edge 316. Similarly, the shoulder node 306 may be associated with the upper arm node 308 by way of an edge 318, the upper arm node 308 may be associated with the lower arm node 310 by way of an edge 320, and the lower arm node 310 may be associated with the hand node 312 by way of an edge 322. Further, the hand node 312 may be associated with the finger nodes 314a-314e by way of respective edges. The edges associating the hand node 312 with the finger nodes 314a-314e are not labeled in FIG. 3 to keep the illustration concise and clear and should not be considered a limitation of the present disclosure.

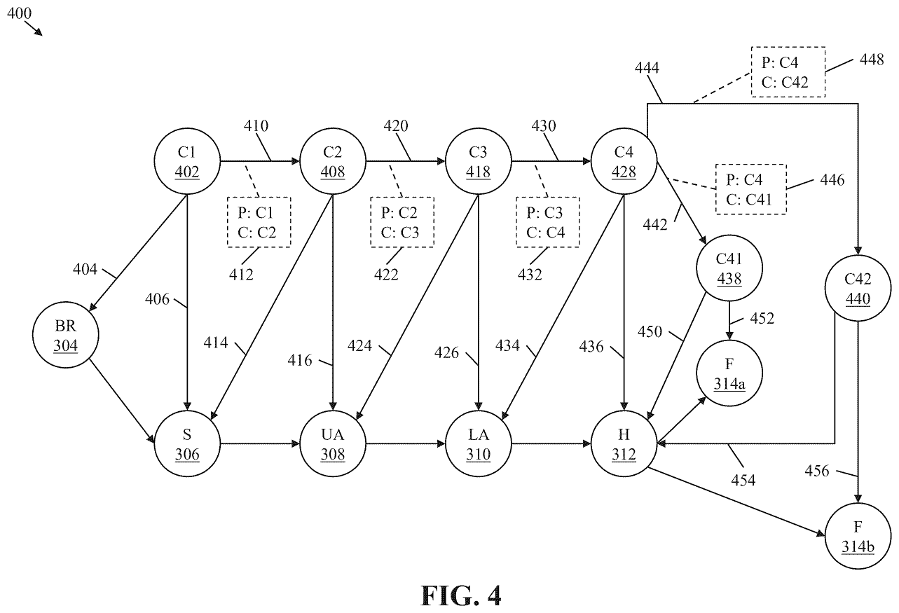

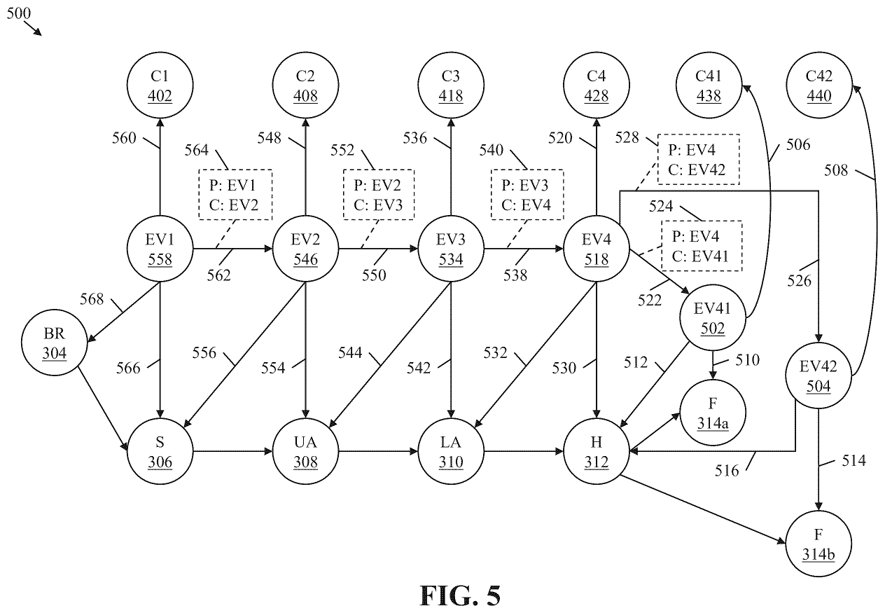

The entity nodes of the graph 300 collectively define the movement of the robotic arm 302. Hence, timely and proper communication using the entity nodes of the graph 300 may be required to ensure seamless operation of the robotic arm 302. The communication between the entity nodes of the graph 300 may be executed by way of compound messaging. Such an architecture is explained in detail in conjunction with FIGS. 4 and 5.

FIG. 4 is a graph 400 illustrating processing of a compound command-type message, consistent with disclosed embodiments of the present disclosure. The graph 400 may correspond to a portion of the directed property graph 110. Referring to FIG. 4, the graph 400 may include the brain node 304, the shoulder node 306, the upper arm node 308, the lower arm node 310, the hand node 312, and the finger nodes 314a and 314b. The finger nodes 314c-314e are not shown in FIG. 4 to keep the illustration concise and clear and should not be considered a limitation of the present disclosure.

The brain node 304, the shoulder node 306, the upper arm node 308, the lower arm node 310, the hand node 312, and the finger nodes 314a and 314b may be associated with each other by way of edges. The edges are not labeled in FIG. 4 to keep the illustration concise and clear and should not be considered a limitation of the present disclosure.

For the robotic arm 302, the brain entity may correspond to a root entity. Thus, the brain node 304 may correspond to a central node that represents the root entity. In such a scenario, the brain node 304 may be utilized to initiate an operation that may require various other entity nodes. For example, the brain node 304 may be utilized to initiate an operation requiring picking up an object using the robotic arm 302. Such an operation may require movement of the shoulder, the upper arm, the lower arm, the hand, and the fingers. To facilitate such an operation, a compound message may be generated. The compound message may include various sub-messages that are to be processed using the shoulder node 306, the upper arm node 308, the lower arm node 310, the hand node 312, and the finger nodes 314a-314e. These sub-messages may be processed in a hierarchical manner to perform the desired operations. The processing of the compound message is explained in detail below.

The processing circuitry 104 may be configured to generate a first message using the brain node 304. In an embodiment, the first message corresponds to a command-type message. The first message may include first through ninth sub-messages linked to the shoulder node 306, the upper arm node 308, the lower arm node 310, the hand node 312, and the finger nodes 314a-314e, respectively. In other words, the first message may include the first sub-message linked to the shoulder node 306 and a first set of sub-messages linked to remaining entity nodes (e.g., the upper arm node 308, the lower arm node 310, the hand node 312, and the finger nodes 314a-314e). The first set of sub-messages may thus include the second through ninth sub-messages. The processing circuitry 104 may be configured to create a message node 402 that represents the first message. Although not shown, the processing circuitry 104 may be further configured to associate at least one of the plurality of attributes associated with the first message as node properties of the message node 402. In an example, the first message may have an ID ‘C1’ which may be associated as the node properties of the message node 402.

The processing circuitry 104 may be further configured to associate the message node 402 with the brain node 304 and the shoulder node 306. To associate the message node 402 with the brain node 304 and the shoulder node 306, the processing circuitry 104 may be further configured to create a message-entity edge 404 between the message node 402 and the brain node 304, and another message-entity edge 406 between the message node 402 and the shoulder node 306. The association of the message node 402 with the brain node 304 indicates that the first message is generated using the brain node 304, whereas the association of the message node 402 with the shoulder node 306 indicates that the first message is to be processed using the shoulder node 306.

Based on the association of the message node 402 with the shoulder node 306, the processing circuitry 104 may be further configured to identify the first sub-message linked to the shoulder node 306 and process the first sub-message using the shoulder node 306. The processing of the first sub-message using the shoulder node 306 may result in the execution of the desired action of the shoulder. Further, based on the processing of the first sub-message, the processing circuitry 104 may be configured to generate a second message that comprises the first set of sub-messages (e.g., remaining sub-messages of the first message). Thus, a portion of the compound message is processed at one entity node and the remaining portion is forwarded as a new message.

The processing circuitry 104 may be further configured to create a message node 408 that represents the second message. Although not shown, the processing circuitry 104 may be further configured to associate at least one of the plurality of attributes associated with the second message as node properties of the message node 408. In an example, the second message may have an ID ‘C2’ which may be associated as the node properties of the message node 408.

The processing circuitry 104 may be further configured to associate the message node 408 with the message node 402. The first message may correspond to a source message of the second message. Thus, the association between the message node 402 and the message node 408 may correspond to a parent-child association, with the message node 402 being a parent and the message node 408 being a child. To associate the message nodes 402 and 408, the processing circuitry 104 may be further configured to create a message edge 410 between the message nodes 402 and 408. Further, the processing circuitry 104 may be configured to determine a set of edge attributes for the message edge 410, and associate the set of edge attributes as edge properties of the message edge 410. The set of edge attributes may include at least one of a group consisting of the ID of the message node 402 or the ID of the message node 408. The edge properties associated with the message edge 410 are illustrated in a dotted box 412. The dotted box 412 is shown to include some of the edge properties in the form of key-value pairs such as parent ID (denoted as “P”): ‘C1’ and child ID (denoted as “C”): ‘C2’.

The processing circuitry 104 may be further configured to associate the message node 408 with the shoulder node 306 and the upper arm node 308. To associate the message node 408 with the shoulder node 306 and the upper arm node 308, the processing circuitry 104 may be further configured to create message-entity edges 414 and 416, respectively. The association of the message node 408 with the shoulder node 306 indicates that the second message is generated using the shoulder node 306, whereas the association of the message node 408 with the upper arm node 308 indicates that the second message is to be processed using the upper arm node 308.

Based on the association of the message node 408 with the upper arm node 308, the processing circuitry 104 may be further configured to identify the second sub-message that is linked to the upper arm node 308 and process the second sub-message using the upper arm node 308. The processing of the second sub-message using the upper arm node 308 may result in the execution of the desired action of the upper arm. Further, based on the processing of the second sub-message, the processing circuitry 104 may be configured generate to a third message. The third message may include a second set of sub-messages (e.g., the third through ninth sub-messages) linked to the remaining entity nodes.

The processing circuitry 104 may be further configured to create a message node 418 that represents the third message. Although not shown, the processing circuitry 104 may be further configured to associate an ID ‘C3’ of the third message as node properties of the message node 418. The processing circuitry 104 may be further configured to associate the message node 418 with the message node 408. The second message may correspond to a source message of the third message. Thus, the association between the message node 408 and the message node 418 may correspond to a parent-child association, with the message node 408 being a parent and the message node 418 being a child. To associate the message nodes 408 and 418, the processing circuitry 104 may be further configured to create a message edge 420 between the message nodes 408 and 418 similarly as described above for the message edge 410. The edge properties associated with the message edge 420 are illustrated in a dotted box 422 in the form of key-value pairs such as P: ‘C2’ and C: ‘C3’. The processing circuitry 104 may be further configured to associate the message node 418 with the upper arm node 308 and the lower arm node 310 by way of message-entity edges 424 and 426, respectively, in a similar manner as described above.

Based on the association of the message node 418 with the lower arm node 310, the processing circuitry 104 may be further configured to identify the third sub-message linked to the lower arm node 310 and process the third sub-message using the lower arm node 310. The processing of the third sub-message using the lower arm node 310 may result in the execution of the desired action of the lower arm. Further, based on the processing of the third sub-message, the processing circuitry 104 may be configured generate to a fourth message. The fourth message may include a third set of sub-messages (e.g., the fourth through ninth sub-messages) linked to the remaining entity nodes.

The processing circuitry 104 may be further configured to create a message node 428 that represents the fourth message and associate an ID ‘C0’ of the fourth message as node properties thereof. Further, the processing circuitry 104 may be configured to associate the message node 428 with the message node 418 by way of a message edge 430 therebetween in a similar manner as described above. The edge properties associated with the message edge 430 are illustrated in a dotted box 432 in the form of key-value pairs such as P: ‘C3’ and C: ‘C4’. The processing circuitry 104 may be further configured to associate the message node 428 with the lower arm node 310 and the hand node 312 by way of message-entity edges 434 and 436, respectively, in a similar manner as described above.

Based on the association of the message node 428 with the hand node 312, the processing circuitry 104 may be further configured to identify the fourth sub-message linked to the hand node 312 and process the fourth sub-message using the hand node 312. The processing of the fourth sub-message using the hand node 312 may result in the execution of the desired action of the hand. Further, based on the processing of the fourth sub-message, the processing circuitry 104 may be configured generate to fifth through ninth messages. The fifth through ninth messages may correspond to the fifth through ninth sub-messages linked to the finger nodes 314a-314e, respectively. For the sake of simplicity, the processing of the fifth and sixth messages is shown in FIG. 4. However, the seventh through ninth messages may be processed similarly, without deviating from the scope of the present disclosure.

The processing circuitry 104 may be further configured to create message nodes 438 and 440 that represent the fifth and sixth messages and associate IDs ‘C41’ and ‘C42’ of the fifth and sixth messages as node properties thereof, respectively.

The fifth and sixth messages are generated from the processing of the fourth message, and hence, the fourth message corresponds to a source message of both the fifth and sixth messages. Further, the processing circuitry 104 may be configured to associate the message nodes 438 and 440 with the message node 428 by way of message edges 442 and 444, respectively, in a similar manner as described above. Thus, the message node 428 may be the parent for both child message nodes 438 and 440. As a result, the edge properties associated with the message edge 442 illustrated in a dotted box 446 in the form of key-value pairs indicate P: ‘C4’ and C: ‘C41’. Similarly, the edge properties associated with the message edge 444 illustrated in a dotted box 448 in the form of key-value pairs indicate P: ‘C4’ and C: ‘C42’. The processing circuitry 104 may be further configured to associate the message node 438 with the hand node 312 and the finger node 314a by way of message-entity edges 450 and 452, respectively, in a similar manner as described above. Further, the processing circuitry 104 may be configured to associate the message node 440 with the hand node 312 and the finger node 314b by way of message-entity edges 454 and 456, respectively, in a similar manner as described above.

Based on the association of the message nodes 438 and 440 with the finger nodes 314a and 314b, the processing circuitry 104 may be further configured to identify and process the fifth and sixth sub-messages using the finger nodes 314a and 314b, respectively. The seventh through ninth sub-messages may be processed similarly. The processing of the fifth through ninth sub-messages may result in the execution of the desired action of the fingers. Thus, using a single compound message, operations at the shoulder, the upper arm, the lower arm, the hand, and the fingers can be executed in a hierarchical manner.

When a message is processed, an event-type message is generated as a response to the message processing. Thus, the processing circuitry 104 may be configured to generate nine event-type messages based on the processing of the first through ninth sub-messages, respectively. The first message described above corresponds to a compound command-type message. The event-type message generated as a response to command processing may include a previous state and an updated state of the corresponding node. Thus, the nine event-type messages may include previous and updated states of the shoulder node 306, the upper arm node 308, the lower arm node 310, the hand node 312, and the finger nodes 314a-314e, respectively.

The event-type messages may also adhere to the same hierarchical structure as the command-type messages. Such hierarchical processing of the event-type messages is illustrated in FIG. 5.

FIG. 5 is a graph 500 illustrating processing of a compound event-type message, consistent with disclosed embodiments of the present disclosure. Referring to FIG. 5, the graph 500 is an extension of the graph 400, and includes the brain node 304, the shoulder node 306, the upper arm node 308, the lower arm node 310, the hand node 312, and the finger nodes 314a and 314b. The finger nodes 314c-314e are not shown in FIG. 5 to keep the illustration concise and clear and should not be considered a limitation of the present disclosure. The graph 500 further includes the message nodes 402, 408, 418, 428, 438, and 440. The association between the message nodes as well as the association of the message nodes with the entity nodes remain the same as described in FIG. 4, and are not illustrated in FIG. 5 to keep the illustration concise and clear, and should not be considered a limitation of the present disclosure.

Since the event-type messages also adhere to the same hierarchical structure as the command-type messages, the processing circuitry 104 may be configured to initially generate the tenth through fourteenth messages using the finger nodes 314a-314b, respectively. The tenth through fourteenth messages correspond to event-type messages generated as responses to the processing of the fifth through ninth sub-messages, respectively. For the sake of simplicity, the processing of the tenth and eleventh messages is shown in FIG. 5. However, the twelfth through fourteenth messages may be processed similarly, without deviating from the scope of the present disclosure. The tenth through fourteenth messages are hereinafter referred to as fifth through ninth events as they are generated as responses to the processing of the fifth through ninth sub-messages, respectively.

The processing circuitry 104 may be configured to create message nodes 502 and 504 that represent the fifth and sixth events. Although not shown, the processing circuitry 104 may be further configured to associate IDs ‘EV41’ and ‘EV42’ of the fifth and sixth events as node properties of the message nodes 502 and 504, respectively.

The processing circuitry 104 may be further configured to associate the message node 502 with the message node 438. To associate the message nodes 502 and 438, the processing circuitry 104 may be further configured to create a message edge 506 between the message nodes 502 and 438. The association of the message nodes 502 and 438 may indicate that the fifth event is generated based on the processing of the fifth sub-message represented by the message node 438. Thus, the fifth sub-message may be a source message of the fifth event. Similarly, the processing circuitry 104 may be further configured to associate the message node 504 with the message node 440 by way of a message edge 508.

The processing circuitry 104 may be further configured to associate the message node 502 with the finger node 314a and the hand node 312. To associate the message node 502 with the finger node 314a and the hand node 312, the processing circuitry 104 may be further configured to create a message-entity edge 510 between the message node 502 and the finger node 314a, and another message-entity edge 512 between the message node 502 and the hand node 312. The association of the message node 502 with the finger node 314a indicates that the fifth event is generated using the finger node 314a, whereas the association of the message node 502 with the hand node 312 indicates that the fifth event is to be processed using the hand node 312. Similarly, the processing circuitry 104 may be further configured to associate the message node 504 with the finger node 314b and the hand node 312 by way of message-entity edges 514 and 516, respectively. The message nodes representing seventh through ninth events may be associated with the hand node 312 in a similar manner as described above.

The processing circuitry 104 may be configured to generate a fifteenth message using the hand node 312. The fifteenth message may include an event-type message generated as a response to the processing of the fourth sub-message using the hand node 312 and the fifth through ninth events. The fifth through ninth events are included in the fifteenth message as the fourth sub-message is the parent (e.g., source) of the fifth through ninth sub-messages. The fifteenth message is hereinafter referred to as a fourth event. The processing circuitry 104 may be configured to create a message node 518 that represents the fourth event. Although not shown, the processing circuitry 104 may be further configured to associate an ID ‘EV4’ of the fourth event as node properties of the message node 518. The processing circuitry 104 may be further configured to associate the message node 518 with the message node 428 by way of a message edge 520 to indicate that the fourth event is generated based on the processing of a portion of the fourth message represented by the message node 428. Thus, the fourth message may be a source message of the fourth event.

The processing circuitry 104 may be further configured to associate the message node 518 with the message nodes 502 and 504. The fourth event may correspond to a source message of both the fifth and sixth events. Thus, the association between the message node 518 and each of the message nodes 502 and 508 may correspond to a parent-child association, with the message node 518 being a parent for both child message nodes 502 and 508. To associate the message nodes 502 and 518, the processing circuitry 104 may be further configured to create a message edge 522 between the message nodes 502 and 518. Further, the processing circuitry 104 may be configured to determine a set of edge attributes for the message edge 522, and associate the set of edge attributes as edge properties of the message edge 522. The set of edge attributes may include at least one of a group consisting of the ID of the message node 502 or the ID of the message node 518. The edge properties associated with the message edge 522 are illustrated in a dotted box 524. The dotted box 524 is shown to include some of the edge properties in the form of key-value pairs such as parent ID (denoted as “P”): ‘EV4’ and child ID (denoted as “C”): ‘EV41’. Similarly, the processing circuitry 104 may be further configured to create a message edge 526 between the message nodes 504 and 518, with the edge properties associated with the message edge 526 being illustrated in a dotted box 528 in the form of key-value pairs such as P: ‘EV4’ and C: ‘EV42’. The message nodes representing seventh through ninth events may be associated with the message node 518 in a similar manner as described above.

The processing circuitry 104 may be further configured to associate the message node 518 with the hand node 312 and the lower arm node 310 by way of message-entity edges 530 and 532, respectively. The association of the message node 518 with the hand node 312 indicates that the fourth event is generated using the hand node 312, whereas the association of the message node 518 with the lower arm node 310 indicates that the fourth event is to be processed using the lower arm node 310.

The processing circuitry 104 may be configured to generate a sixteenth message using the lower arm node 310. The sixteenth message may include an event-type message generated as a response to the processing of the third sub-message using the lower arm node 310 and the fourth event. The sixteenth message is hereinafter referred to as a third event. The processing circuitry 104 may be configured to create a message node 534 that represents the third event. Although not shown, the processing circuitry 104 may be further configured to associate an ID ‘EV3’ of the third event as node properties of the message node 534. The processing circuitry 104 may be further configured to associate the message node 534 with the message node 418 by way of a message edge 536 to indicate that the third event is generated based on the processing of a portion of the third message represented by the message node 418. Thus, the third message may be a source message of the third event.

The processing circuitry 104 may be further configured to associate the message node 534 with the message node 518 by way of a message edge 538 in a similar manner as the association between the message nodes 518, 502, and 504. The edge properties associated with the message edge 538 are illustrated in a dotted box 540. The dotted box 540 is shown to include some of the edge properties in the form of key-value pairs such as P: ‘EV3’ and C: ‘EV4’. Thus, the message edge 538 may indicate that the third event is the source message of the fourth event.

The processing circuitry 104 may be further configured to associate the message node 534 with the lower arm node 310 and the upper arm node 308 by way of message-entity edges 542 and 544, respectively. The association of the message node 534 with the lower arm node 310 indicates that the third event is generated using the lower arm node 310, whereas the association of the message node 534 with the upper arm node 308 indicates that the third event is to be processed using the upper arm node 308.

The processing circuitry 104 may be configured to generate a seventeenth message using the upper arm node 308. The seventeenth message may include an event-type message generated as a response to the processing of the second sub-message using the upper arm node 308 and the third event. The seventeenth message is hereinafter referred to as a second event. The processing circuitry 104 may be configured to create a message node 546 that represents the second event. Although not shown, the processing circuitry 104 may be further configured to associate an ID ‘EV2’ of the second event as node properties of the message node 546. The processing circuitry 104 may be further configured to associate the message node 546 with the message node 408 by way of a message edge 548 to indicate that the second event is generated based on the processing of a portion of the second message represented by the message node 408. Thus, the second message may be a source message of the second event.

The processing circuitry 104 may be further configured to associate the message node 546 with the message node 534 by way of a message edge 550 to indicate that the message node 546 is a parent and the message node 534 is a child. The edge properties associated with the message edge 550 are illustrated in a dotted box 552. The dotted box 552 is shown to include some of the edge properties in the form of key-value pairs such as P: ‘EV2’ and C: ‘EV3’. Thus, the message edge 550 may indicate that the second event is the source message of the third event.

The processing circuitry 104 may be further configured to associate the message node 546 with the upper arm node 308 and the shoulder node 306 by way of message-entity edges 554 and 556, respectively. The association of the message node 546 with the upper arm node 308 indicates that the second event is generated using the upper arm node 308, whereas the association of the message node 546 with the shoulder node 306 indicates that the second event is to be processed using the shoulder node 306.

The processing circuitry 104 may be configured to generate an eighteenth message using the shoulder node 306. The eighteenth message may include an event-type message generated as a response to the processing of the first sub-message using the shoulder node 306 and the second event. The eighteenth message is hereinafter referred to as a first event. The processing circuitry 104 may be configured to create a message node 558 that represents the first event. Although not shown, the processing circuitry 104 may be further configured to associate an ID ‘EV1’ of the first event as node properties of the message node 558. The processing circuitry 104 may be further configured to associate the message node 558 with the message node 402 by way of a message edge 560 to indicate that the first event is generated based on the processing of a portion of the first message represented by the message node 402. Thus, the first message may be a source message of the first event.

The processing circuitry 104 may be further configured to associate the message node 558 with the message node 546 by way of a message edge 562. The association between the message nodes 546 and 558 corresponds to a parent-child association, with the message node 558 being a parent and the message node 546 being a child. The edge properties associated with the message edge 562 are illustrated in a dotted box 564. The dotted box 564 is shown to include some of the edge properties in the form of key-value pairs such as P: ‘EV1’ and C: ‘EV2’. Thus, the message edge 562 may indicate that the first event is the source message of the second event.

The processing circuitry 104 may be further configured to associate the message node 558 with the shoulder node 306 and the brain node 304 by way of message-entity edges 566 and 568, respectively. The association of the message node 558 with the shoulder node 306 indicates that the first event is generated using the shoulder node 306, whereas the association of the message node 558 with the brain node 304 indicates that the first event is to be processed using the brain node 304. The processing circuitry 104 may be further configured to process the first event using brain node 304.

Thus, the first message may correspond to a compound command-type message, and the first event corresponds to a compound event-type message. The first event may be a response to the first message. For example, if the first message corresponds to a command of picking up an object with specific actions to be performed by each of the shoulder, upper and lower arms, hand, and fingers, the first event may correspond to previous and current states of the shoulder, upper and lower arms, hand, and fingers, which may indicate whether the object was picked up. The compound messaging may thus be executed using the directed property graph 110.

The aforementioned process may be executed for various compound messages generated for the robotic arm 302. Such a structure of the directed property graph 110 (e.g., the graphs 400 and 500) may facilitate optimized query processing. In an embodiment, the processing circuitry 104 may be configured to receive a query. The query may include a reference value. The processing circuitry 104 may be configured to identify, in the graphs 400 and 500 (e.g., the directed property graph 110), at least one node having a data value that is associated with the reference value. The identified node may correspond to one of a group consisting of an entity node or a message node. Further, the processing circuitry 104 may be configured to identify a set of edges associated with the identified node, and a set of nodes linked to the identified set of edges. The identified set of nodes may include at least one of a group consisting of one or more message nodes or one or more entity nodes. The processing circuitry 104 may be configured to generate a response to the query based on at least one of a group consisting of the identified node, the set of edges, or the set of nodes. The directed property graph 110 may thus facilitate query response generation. The query response may be utilized to derive real-time analytics associated with the robotic arm 302. Examples of the real-time analytics may include auditing of various compound operations executed by the robotic arm 302, current states of various entities of the robotic arm 302, the processing load associated with various entities of the robotic arm 302, or the like.

The edge properties of the message-entity edges and message edges coupling event and command message nodes are not illustrated in FIGS. 4 and 5 to keep the illustrations concise and clear, and should not be considered a limitation of the present disclosure.

The first message described above corresponds to a compound command-type message. The scope of the present disclosure is not limited to the processing of a compound command-type message. In numerous embodiments, the first message may correspond to a compound query-type message. In such scenarios, the compound query-type message may be processed similarly as described above. When a query-type message is processed, the event-type message may include a current state of the corresponding node. Thus, the first event that is generated as a response to query processing may include current states of the shoulder, upper and lower arms, hand, and fingers.

The scope of the present disclosure is not limited to the compound event-type messages being generated as a response to the processing of a compound command-type message or a compound query-type message. In several embodiments, compound event-type messages may be generated based on the processing of an atomic command or query message by one of the entity nodes. For example, an atomic query message querying the status of the hand and fingers may be processed using the hand node 312 and events may be generated using all finger nodes 314a-314e as well as the hand node 312. Further, all the events (e.g., events generated using the finger nodes 314a-314e and the hand node 312) constituting a single compound event-type message may be provided as the response to the query message. In such a scenario, the query message may be the source message of all the events.

Although it is described that the processing of the compound command-type message results in the generation of a compound event-type message, the scope of the present disclosure is not limited to it. In numerous embodiments, the event-type message generated as a response to the message processing at each node may be processed separately (e.g., atomically) using the brain node 304.

Although it is described that a portion of the compound message (e.g., a sub-message of the compound message) is processed using one entity node and the remaining portion is forwarded for processing using the next entity node, the scope of the present disclosure is not limited to it. In various embodiments, the forwarded message may further include a modified version of the processed sub-message.

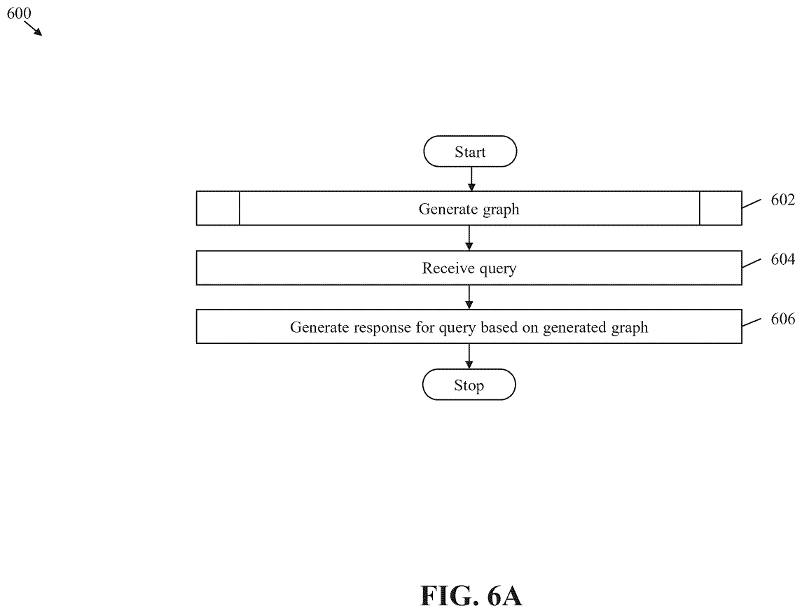

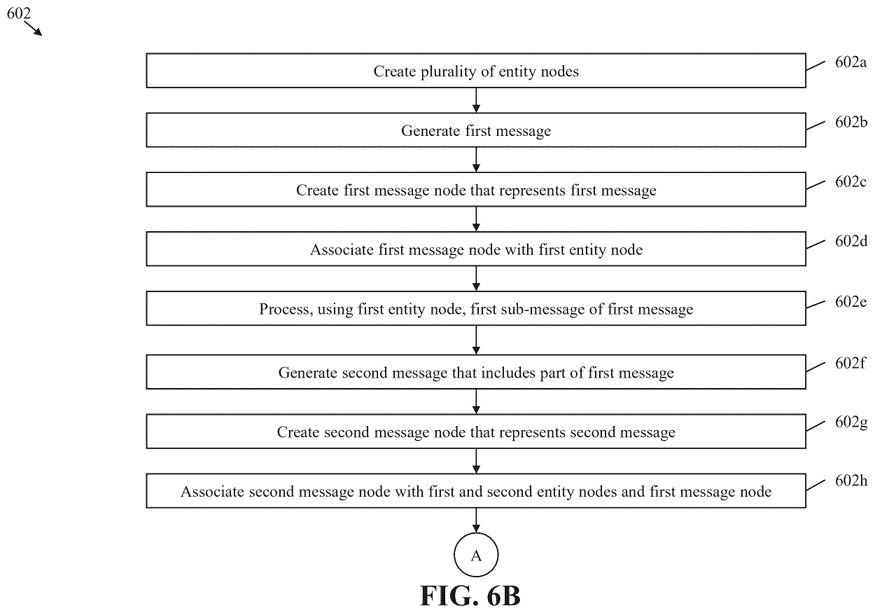

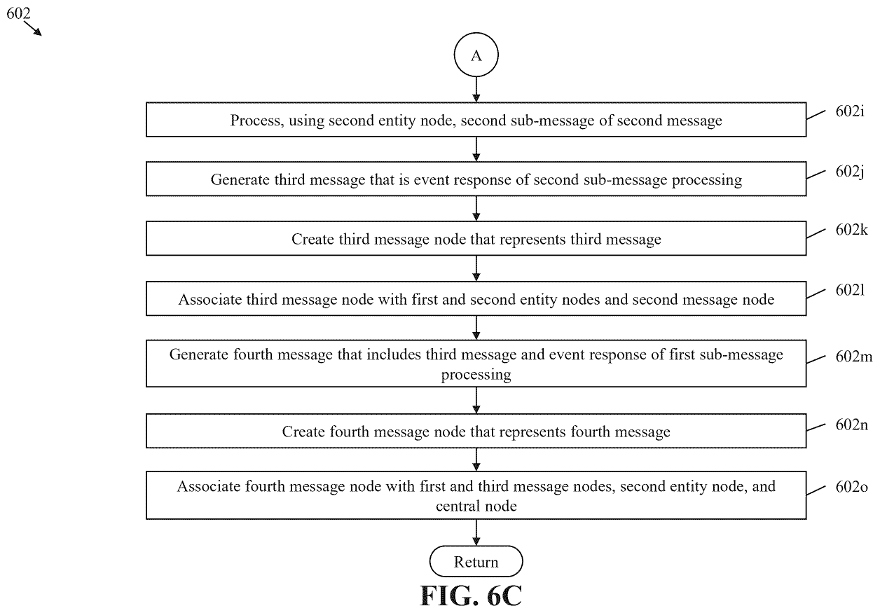

FIGS. 6A-6C, collectively, represents a flowchart 600 that illustrates a method for facilitating compound messaging using directed property graphs, consistent with disclosed embodiments of the present disclosure.

Referring to FIG. 6A, at 602, the processing circuitry 104 may generate a graph (e.g., the directed property graph 110). The generation of the graph is explained in conjunction with FIGS. 6B and 6C.

Referring to FIG. 6B, at 602a, the processing circuitry 104 may create a plurality of entity nodes. The plurality of entity nodes may represent a plurality of entities of the real-time system 102. At 602b, the processing circuitry 104 may generate a first message. The first message may be a compound message that includes a first sub-message linked to a first entity node of the plurality of entity nodes and a first set of sub-messages linked to the remaining entity nodes of the plurality of entity nodes. At 602c, the processing circuitry 104 may create a first message node that represents the first message. At 602d, the processing circuitry 104 may associate the first message node with the first entity node. At 602e, the processing circuitry 104 may process, using the first entity node, the first sub-message of the first message.

At 602f, the processing circuitry 104 may generate a second message that includes part of the first message. In other words, the second message may include the first set of sub-messages of the first message. At 602g, the processing circuitry 104 may create a second message node that represents the second message. The second message may include a second sub-message that is linked to a second entity node of the plurality of entity nodes. At 602h, the processing circuitry 104 may associate the second message node with the first and second entity nodes and the first message node.

Referring to FIG. 6C, at 602i, the processing circuitry 104 may process, using the second entity node, the second sub-message of the second message. At 602j, the processing circuitry 104 may generate a third message that is event response of the second sub-message processing. At 602k, the processing circuitry 104 may create a third message node that represents the third message. At 6021, the processing circuitry 104 may associate the third message node with the first and second entity nodes and the second message node. At 602m, the processing circuitry 104 may generate a fourth message that includes the third message and the event response of the first sub-message processing. At 602n, the processing circuitry 104 may create a fourth message node that represents the fourth message. At 6020, the processing circuitry 104 may associate the fourth message node with the first and third message nodes, the second entity node, and a central node. The fourth message may be processed using the central node.

Referring back to FIG. 6A, at 604, the processing circuitry 104 may receive a query. The query may be generated by the real-time system 102. At 606, the processing circuitry 104 may generate a response for the query based on the generated graph.

FIG. 7 illustrates an example computing system 700 for carrying out the methods of the present disclosure, consistent with disclosed embodiments of the present disclosure. Specifically, FIG. 7 shows a block diagram of an embodiment of the computing system 700 according to example embodiments of the present disclosure.

The computing system 700 may be configured to perform any of the operations disclosed herein. The computing system 700 can be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 700 is a distributed system configured to function using multiple computing machines interconnected via a data network or bus system.

The computing system 700 includes computing devices (such as a computing device 702). The computing device 702 includes one or more processors (such as a processor 704) and a memory 706. The processor 704 may be any general-purpose processor(s) configured to execute a set of instructions. For example, the processor 704 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 704 may be multiple processing units, a single processing core, multiple processing cores, special purpose processing cores, co-processors, or any combination thereof. The processor 704 may be communicatively coupled to the memory 706 via an address bus 708, a control bus 710, a data bus 712, and a messaging bus 714.

The memory 706 may include non-volatile memories such as a read-only memory (ROM), a programable read-only memory (PROM), an erasable programmable read-only memory (EPROM), a flash memory, or any other device capable of storing program instructions or data with or without applied power. The memory 706 may also include volatile memories, such as a random-access memory (RAM), a static random-access memory (SRAM), a dynamic random-access memory (DRAM), and a synchronous dynamic random-access memory (SDRAM). The memory 706 may include single or multiple memory modules. While the memory 706 is depicted as part of the computing device 702, a person skilled in the art will recognize that the memory 706 can be separate from the computing device 702.

The memory 706 may store information that can be accessed by the processor 704. For instance, the memory 706 (e.g., one or more non-transitory computer-readable storage mediums, memory devices) may include computer-readable instructions (not shown) that can be executed by the processor 704. The computer-readable instructions may be software written in any suitable programming language or may be implemented in hardware. Additionally, or alternatively, the computer-readable instructions may be executed logically and/or virtually separate threads on the processor 704. For example, the memory 706 may store instructions (not shown) that when executed by the processor 704 cause the processor 704 to perform operations such as any of the operations and functions for which the computing system 700 is configured, as described herein. Additionally, or alternatively, the memory 706 may store data (not shown) that can be obtained, received, accessed, written, manipulated, created, and/or stored. The data can include, for instance, the data and/or information described herein in relation to FIGS. 1-6. In some implementations, the computing device 702 may obtain from and/or store data in one or more memory device(s) that are remote from the computing system 700.

The computing device 702 may further include an input/output (I/O) interface 716 communicatively coupled to the address bus 708, the control bus 710, and the data bus 712. The data bus 712 and messaging bus 714 may include a plurality of tunnels that may support parallel processing of messages. The I/O interface 716 is configured to couple to one or more external devices (e.g., to receive and send data from/to one or more external devices). Such external devices, along with the various internal devices, may also be known as peripheral devices. The I/O interface 716 may include both electrical and physical connections for operably coupling the various peripheral devices to the computing device 702. The I/O interface 716 may be configured to communicate data, addresses, and control signals between the peripheral devices and the computing device 702. The I/O interface 716 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, Fire Wire, various video buses, or the like. The I/O interface 716 is configured to implement only one interface or bus technology. Alternatively, the I/O interface 716 is configured to implement multiple interfaces or bus technologies. The I/O interface 716 may include one or more buffers for buffering transmissions between one or more external devices, internal devices, the computing device 702, or the processor 704. The I/O interface 716 may couple the computing device 702 to various input devices, including mice, touch screens, scanners, biometric readers, electronic digitizers, sensors, receivers, touchpads, trackballs, cameras, microphones, keyboards, any other pointing devices, or any combinations thereof. The I/O interface 716 may couple the computing device 702 to various output devices, including video displays, speakers, printers, projectors, tactile feedback devices, automation control, robotic components, actuators, motors, fans, solenoids, valves, pumps, transmitters, signal emitters, lights, and so forth.

The computing system 700 may further include a storage unit 718, a network interface 720, an input controller 722, and an output controller 724. The storage unit 718, the network interface 720, the input controller 722, and the output controller 724 are communicatively coupled to the central control unit (e.g., the memory 706, the address bus 708, the control bus 710, and the data bus 712) via the I/O interface 716. The network interface 720 communicatively couples the computing system 700 to one or more networks such as wide area networks (WAN), local area networks (LAN), intranets, the Internet, wireless access networks, wired networks, mobile networks, telephone networks, optical networks, or combinations thereof. The network interface 720 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 718 is a computer-readable medium, preferably a non-transitory computer-readable medium, comprising one or more programs, the one or more programs comprising instructions which when executed by the processor 704 cause the computing system 700 to perform the method steps of the present disclosure. Alternatively, the storage unit 718 is a transitory computer-readable medium. The storage unit 718 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 718 stores one or more operating systems, application programs, program modules, data, or any other information. The storage unit 718 is part of the computing device 702. Alternatively, the storage unit 718 is part of one or more other computing machines that are in communication with the computing device 702, such as servers, database servers, cloud storage, network attached storage, and so forth.

The input controller 722 may include suitable logic, circuitry, interfaces, and/or code, executable by the circuitry, that may be configured to control one or more input devices that may be configured to receive an input (e.g., the query) generated by the real-time system 102. The output controller 724 may include suitable logic, circuitry, interfaces, and/or code, executable by the circuitry, that may be configured to control one or more output devices that may be configured to render/output the outcome of the operation executed to process the received input.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for compound messaging using directed property graphs. While various embodiments of the disclosed systems and methods have been described above, it should be understood that they have been presented for purposes of example only, and not limitations. It is not exhaustive and does not limit the present disclosure to the precise form disclosed. Modifications and variations are possible in light of the above teachings or may be acquired from practicing the present disclosure, without departing from the breadth or scope.

Moreover, for example, the present technology/system may achieve the following configurations:
1. A system, comprising:
   processing circuitry configured to generate a graph, wherein to generate the graph, the processing circuitry is further configured to:
      create a plurality of entity nodes representing a plurality of entities;
      create a first message node that represents a first message, wherein the first message comprises (i) a first sub-message linked to a first entity node of the plurality of entity nodes and (ii) a first set of sub-messages linked to a first set of remaining entity nodes of the plurality of entity nodes;
      associate the first message node with the first entity node;
      process, using the first entity node, the first sub-message; and
      generate, based on the processing of the first sub-message, a second message that comprises the first set of sub-messages.
2. The system of 1, wherein the first message corresponds to a command-type message or a query-type message.
3. The system of 1, wherein to generate the graph, the processing circuitry is further configured to create a second message node that represents the second message, and associate the second message node with the first message node and the first entity node.
4. The system of 3, wherein the association between the first message node and the second message node corresponds to a parent-child association, with the first message node being a parent and the second message node being a child.
5. The system of 3, wherein to associate the first message node and the second message node, the processing circuitry is further configured to:
   create a message edge between the first message node and the second message node;
   determine, for the message edge, a set of edge attributes that comprises at least one of a group consisting of (i) an identifier of the first message node or (ii) an identifier of the second message node; and
   associate the set of edge attributes as edge properties of the message edge.
6. The system of 1, wherein the first set of sub-messages of the second message comprises a second sub-message that is linked to a second entity node of the first set of remaining entity nodes, and wherein the processing circuitry is further configured to process the second sub-message using the second entity node, and generate, based on the processing of the second sub-message, a third message that corresponds to an event-type message generated as a response to the processing of the second sub-message.
7. The system of 6, wherein the second message corresponds to a source message of the third message.
8. The system of 6, wherein to generate the graph, the processing circuitry is further configured to:
   create a second message node that represents the second message;
   associate the second message node with the second entity node;
   create a third message node that represents the third message; and
   associate the third message node with the second message node and the second entity node.
9. The system of 6, wherein to generate the graph, the processing circuitry is further configured to associate the second entity node with the first entity node.
10. The system of 6, wherein the processing circuitry is further configured to generate a fourth message that comprises the third message and an event-type message generated as a response to the processing of the first sub-message.
11. The system of 10, wherein to generate the graph, the processing circuitry is further configured to:
   create a second message node that represents the second message;
   associate the second message node with the second entity node;
   create a third message node that represents the third message;
   associate the third message node with the second message node, the second entity node, and the first entity node;
   create a fourth message node that represents the fourth message; and
   associate the fourth message node with the first message node, the first entity node, and the third message node.
12. The system of 11, wherein the association between the third message node and the fourth message node corresponds to a parent-child association, with the fourth message node being a parent and the third message node being a child.
13. The system of 10, wherein the first message corresponds to a source message of the fourth message.
14. The system of 10, wherein the first message corresponds to a compound command-type message or a compound query-type message, and wherein the fourth message corresponds to a compound event-type message.
15. The system of 10,
   wherein the first message further comprises a second set of sub-messages linked to a second set of remaining entity nodes of the plurality of entity nodes,
   wherein based on the processing of the first sub-message, the processing circuitry is further configured to generate a fifth message that comprises the second set of sub-messages,
   wherein the second set of sub-messages of the fifth message comprises a third sub-message that is linked to a third entity node of the second set of remaining entity nodes,
   wherein the processing circuitry is further configured to process the third sub-message using the third entity node, and generate, based on the processing of the third sub-message, a sixth message that corresponds to an event-type message generated as a response to the processing of the third sub-message, and
   wherein the fourth message further comprises the sixth message.
16. The system of 1, wherein the first set of sub-messages of the second message comprises (i) a second sub-message that is linked to a second entity node of the first set of remaining entity nodes, and (ii) at least one sub-message linked to an entity node, of the first set of remaining entity nodes, that is different from the second entity node, and wherein the processing circuitry is further configured to process the second sub-message using the second entity node, and generate, based on the processing of the second sub-message, a seventh message that comprises the at least one sub-message.
17. The system of 1, wherein the second message further comprises a modified version of the first sub-message that is derived based on the processing thereof.
18. The system of 1, wherein the plurality of entities comprises a root entity, wherein the plurality of entity nodes comprises a central node representing the root entity, and wherein the processing circuitry is further configured to generate the first message using the central node.
19. The system of 18, wherein to generate the graph, the processing circuitry is further configured to associate the first message node with the central node.
20. The system of 1, wherein to associate the first message node with the first entity node, the processing circuitry is further configured to create a message-entity edge between the first message node and the first entity node.
21. The system of 1, wherein the processing circuitry is further configured to:
   receive a query that comprises a reference value;
   identify, in the graph, at least one node having a data value that is associated with the reference value, wherein the identified node corresponds to one of a group consisting of an entity node or a message node;
   identify a set of edges associated with the identified node;
   identify a set of nodes linked to the identified set of edges, wherein the identified set of nodes includes at least one of a group consisting of one or more message nodes or one or more entity nodes; and
   generate a response to the query based on at least one of a group consisting of (i) the identified node, (ii) the set of edges, or (iii) the set of nodes.
22. A method, comprising:
   generating, by processing circuitry, a graph, wherein the step of generating the graph further comprises:
      creating, by the processing circuitry, a plurality of entity nodes representing a plurality of entities;
      creating, by the processing circuitry, a first message node that represents a first message, wherein the first message comprises (i) a first sub-message linked to a first entity node of the plurality of entity nodes and (ii) a first set of sub-messages linked to a first set of remaining entity nodes of the plurality of entity nodes;
      associating, by the processing circuitry, the first message node with the first entity node;
      processing, by the processing circuitry, using the first entity node, the first sub-message; and
      generating, by the processing circuitry, based on the processing of the first sub-message, a second message that comprises the first set of sub-messages.
23. A system, comprising:
   processing circuitry configured to generate a graph, wherein to generate the graph, the processing circuitry is further configured to:
   create a plurality of entity nodes representing a plurality of entities, with a first entity node being associated with a second entity node;
   generate, using the first entity node, a first message, wherein the first message corresponds to an event-type message generated as a response to message processing using the first entity node;
   create a first message node that represents the first message;
   associate the first message node with the first entity node and the second entity node; and
   generate, using the second entity node, a second message, wherein the second message comprises the first message and an event-type message generated as a response to message processing using the second entity node.
24. The system of 23, wherein to generate the graph, the processing circuitry is further configured to create a second message node that represents the second message, and associate the second message node with the first message node and the second entity node.
25. The system of 24, wherein the association between the first message node and the second message node corresponds to a parent-child association, with the second message node being a parent and the first message node being a child.
26. The system of 24, wherein to associate the first message node and the second message node, the processing circuitry is further configured to:
   create a message edge between the first message node and the second message node;
   determine, for the message edge, a set of edge attributes that comprises at least one of a group consisting of (i) an identifier of the first message node or (ii) an identifier of the second message node; and
   associate the set of edge attributes as edge properties of the message edge.
27. The system of 23, wherein the processing circuitry is configured to process, using the first entity node, a third message that corresponds to a command-type message or a query-type message, and wherein the processing circuitry generates the first message and the second message as a response to the processing of the third message.
28. The system of 27, wherein the third message corresponds to a source message of the first message and the second message.
29. The system of 23, wherein the processing circuitry is configured to process, using the first entity node, a third message that corresponds to a command-type message or a query-type message, wherein the processing circuitry is configured to process, using the second entity node, a fourth message that corresponds to a command-type message or a query-type message, and wherein the processing circuitry generates the first message and the second message as a response to the processing of the third message and the fourth message, respectively.
30. The system of 29, wherein the third message corresponds to a source message of the first message, and the fourth message corresponds to a source message of the second message.
31. The system of 23, wherein the second message corresponds to a compound event-type message.
32. The system of 23, wherein to generate the graph, the processing circuitry is further configured to generate, using a third entity node of the plurality of entity nodes, a fifth message, wherein the third entity node is associated with the second entity node, wherein the fifth message corresponds to an event-type message generated as a response to message processing using the third entity node, and wherein the second message further comprises the fifth message.
33. The system of 23, wherein the processing circuitry is further configured to:
   receive a query that comprises a reference value;
   identify, in the graph, at least one node having a data value that is associated with the reference value, wherein the identified node corresponds to one of a group consisting of an entity node or a message node;
   identify a set of edges associated with the identified node;
   identify a set of nodes linked to the identified set of edges, wherein the identified set of nodes includes at least one of a group consisting of one or more message nodes or one or more entity nodes; and
   generate a response to the query based on at least one of a group consisting of (i) the identified node, (ii) the set of edges, or (iii) the set of nodes.

1. A system, comprising:
processing circuitry configured to generate a graph,
wherein to generate the graph, the processing circuitry is further configured to:
create a plurality of entity nodes representing a plurality of entities,
wherein each entity node corresponds to a system entity of a distributed system;
create a first message node that represents a first message, wherein the first message comprises each of:
a first sub-message linked to a first entity node of the plurality of entity nodes, and
a first set of sub-messages, each having a unique identifier, linked to a first set of remaining entity nodes of the plurality of entity nodes,
wherein the first set of remaining entity nodes being entity nodes of the plurality of entity nodes excluding the first entity node;
associate the first message node with the first entity node;
process, using the first entity node, the first sub-message; and
generate, based on the processing of the first sub-message, a second message that comprises the first set of sub-messages, wherein the second message is represented by a second message node associated with the first message node and the first entity node.

2. The system of claim 1, wherein the first message corresponds to a command-type message or a query-type message.

3. The system of claim 1, wherein to generate the graph, the processing circuitry is further configured to: create the second message node that represents the second message, and associate the second message node with the first message node and the first entity node.

4. The system of claim 3, wherein the association between the first message node and the second message node corresponds to a parent-child association, with the first message node being a parent and the second message node being a child.

5. The system of claim 3, wherein to associate the first message node and the second message node, the processing circuitry is further configured to:
create a message edge between the first message node and the second message node;
determine, for the message edge, a set of edge attributes that comprises at least one of a group consisting of (i) a unique identifier of the first message node or (ii) a unique identifier of the second message node; and
associate the set of edge attributes as edge properties of the message edge.

6. The system of claim 1, wherein the first set of sub-messages of the second message comprises a second sub-message that is linked to a second entity node of the first set of remaining entity nodes, and wherein the processing circuitry is further configured to process the second sub-message using the second entity node, and generate, based on the processing of the second sub-message, a third message that corresponds to an event-type message generated as a response to the processing of the second sub-message,
wherein the second sub-message object is associated with a unique identifier and is processed using the second entity node independently of processing of the first sub-message.

7. The system of claim 6, wherein the second message corresponds to a source message of the third message.

8. The system of claim 6, wherein to generate the graph, the processing circuitry is further configured to: create a second message node that represents the second message; associate the second message node with the second entity node; create a third message node that represents the third message; and associate the third message node with the second message node and the second entity node.

9. The system of claim 6, wherein the processing circuitry is further configured to generate a fourth message that comprises the third message and an event-type message generated as a response to the processing of the first sub-message.

10. The system of claim 9, wherein to generate the graph, the processing circuitry is further configured to:
create a second message node that represents the second message;
associate the second message node with the second entity node;
create a third message node that represents the third message;
associate the third message node with the second message node, the second entity node, and the first entity node;
create a fourth message node that represents the fourth message; and
associate the fourth message node with the first message node, the first entity node, and the third message node.

11. The system of claim 10, wherein the association between the third message node and the fourth message node corresponds to a parent-child association, with the fourth message node being a parent and the third message node being a child.

12. The system of claim 9, wherein the first message corresponds to a source message of the fourth message.

13. The system of claim 9,
wherein the first message further comprises a second set of sub-messages linked to a second set of entity nodes excluding the first entity node,
wherein based on the processing of the first sub-message, the processing circuitry is further configured to generate a fifth message that comprises the second set of sub-messages,
wherein the second set of sub-messages of the fifth message comprises a third sub-message that is linked to a third entity node of the second set of entity nodes,
wherein the processing circuitry is further configured to process the third sub-message using the third entity node, and generate, based on the processing of the third sub-message, a sixth message that corresponds to an event-type message generated as a response to the processing of the third sub-message, and
wherein the fourth message further comprises the sixth message.

14. The system of claim 1,
wherein the first set of sub-messages of the second message comprises (i) a second sub-message that is linked to a second entity node of the first set of remaining entity nodes, and (ii) at least one sub-message linked to an entity node, of the first set of remaining entity nodes, that is different from the second entity node, and
wherein the processing circuitry is further configured to process the second sub-message using the second entity node, and generate, based on the processing of the second sub-message, a seventh message that comprises the at least one sub-message.

15. The system of claim 1,
wherein the plurality of entities comprises a root entity,
wherein the plurality of entity nodes comprises a central node representing the root entity, and
wherein the processing circuitry is further configured to generate the first message using the central node.

16. The system of claim 1, wherein the processing circuitry is further configured to:
receive a query that comprises a reference value;
identify, in the graph, at least one node having a data value that is associated with the reference value, wherein the identified node corresponds to one of a group consisting of an entity node or a message node;
identify a set of edges associated with the identified node;
identify a set of nodes linked to the identified set of edges, wherein the identified set of nodes includes at least one of a group consisting of one or more message nodes or one or more entity nodes; and
generate a response to the query based on at least one of a group consisting of (i) the identified node, (ii) the set of edges, or (iii) the set of nodes.

17. A method, comprising:
generating, by processing circuitry, a graph, wherein the step of generating the graph further comprises:
creating, by the processing circuitry, a plurality of entity nodes representing a plurality of entities, wherein each entity node corresponds to a system entity of a distributed system;
creating, by the processing circuitry, a first message node that represents a first message, wherein the first message comprises each of:
a first sub-message linked to a first entity node of the plurality of entity nodes, and
a first set of sub-messages, each having a unique identifier, linked to a first set of remaining entity nodes of the plurality of entity nodes,
wherein the first set of remaining entity nodes being entity nodes of the plurality of entity nodes excluding the first entity node;
associating, by the processing circuitry, the first message node with the first entity node;
processing, by the processing circuitry, using the first entity node, the first sub-message; and
generating, by the processing circuitry, based on the processing of the first sub-message, a second message that comprises the first set of sub-messages,
wherein the second message is represented by a second message node associated with the first message node and the first entity node.

18. A system, comprising:
processing circuitry configured to generate a graph, wherein to generate the graph, the processing circuitry is further configured to:
create a plurality of entity nodes representing a plurality of entities, with a first entity node being associated with a second entity node, wherein each entity node corresponds to a system entity of a distributed system;
generate, using the first entity node, a first message;
create a first message node that represents the first message;
associate the first message node with the first entity node and the second entity node; and
generate, using the second entity node, a second message, wherein the second message comprises the first message and an event-type message generated as a response to message processing using the second entity node, wherein the second message is represented by a second message node associated with the first message node and the first entity node.

19. The system of claim 18, wherein the processing circuitry is configured to process, using the first entity node, a third message that corresponds to a command-type message or a query-type message, and generate the first message and the second message as responses to the processing of the third message.

20. The system of claim 18, wherein the processing circuitry is configured to process, using the first entity node, a third message that corresponds to a command-type message or a query-type message, process, using the second entity node, a fourth message that corresponds to a command-type message or a query-type message, and generate the first message and the second message as responses to the processing of the third message and the fourth message, respectively.
